(19) United States
(12) Patent Application Publication
(10) Pub. No.: US 2017/0323093 A1
(43) Pub. Date: Nov. 9, 2017

(54) VERIFICATION METHOD AND APPARATUS FOR DISTINGUISHING MAN FROM MACHINE

(71) Applicant: BAIDU ONLINE NETWORK TECHNOLOGY (BEIJING) CO., LTD., Beijing (CN)

(72) Inventors: Wenyang LIU, Beijing (CN); Chang Gao, Beijing (CN)

(73) Assignee: BAIDU ONLINE NETWORK TECHNOLOGY (BEIJING) CO., LTD., Beijing (CN)

(21) Appl. No.: 15/498,235

(22) Filed: Apr. 26, 2017

(30) Foreign Application Priority Data
May 5, 2016 (CN) 201610292900.7

(51) Int. Cl. G06F 21/36; G06F 3/0481; G06F 3/0482; G06F 3/0488

(52) U.S. Cl. CPC G06F 21/36; G06F 3/0488; G06F 3/04817; G06F 3/0482; G06F 2221/2133

(57) ABSTRACT

The present disclosure provides a verification method for distinguishing a man from a machine, wherein the method comprises: S1: receiving trajectory information input by a terminal; S2: comparing the trajectory information with a preset trajectory; S3: judging whether verification passes at least from dimensionality of a comparison result of the trajectory information and the preset trajectory. As compared with the prior art, the verification method and apparatus for distinguishing a man from a machine in the present disclosure may recognize user identity through simpler operation, and particularly applied to the mobile device, may bring about better user experience, and meanwhile exhibit very high security and difficulty in cracking the machine.

The present application claims the priority of Chinese Patent Application No. 201610292900.7, filed on May 5, 2016, with the title of “Verification method and apparatus for distinguishing man from machine”.

### FIELD OF THE DISCLOSURE

The present disclosure relates to a verification method and apparatus for distinguishing a man from machine, and particularly to a verification method and apparatus for distinguishing a man from a machine by using a slide verification code.

### BACKGROUND OF THE DISCLOSURE

As mobile Internet technologies develop, people's habit of surfing the Internet has changed greatly. The time spent by people in using the Internet on a mobile device has already by far exceeded the time spent on a PC.

However, currently a verification code for judging whether a man or a machine is performing current operation stays at a PC era. Its operation manner has already seriously failed to conform to the use habit of the mobile device and mainly comprises two types: one type is allowing the user to input text content, and this manner is complicated in operation and does not conform to the operation habit of the mobile device. The other manner is allowing the user to select designated content from options, and this manner still cannot completely adapt for the mobile terminal and can be easily cracked in an exhaustive manner.

### SUMMARY OF THE DISCLOSURE

One of objectives of the present disclosure is to provide a verification method and apparatus for distinguishing a man from a machine. The verification method and apparatus for distinguishing a man from a machine according to the present disclosure employ a slide manner in place of a conventional text input manner or a manner of selecting designated content, to more conform to a habit of using a mobile device.

To implement one of the above objectives of the present disclosure, an embodiment of the present disclosure provides a verification method for distinguishing a man from a machine, comprising:

S1: receiving trajectory information input by a terminal;

S2: comparing the trajectory information with a preset trajectory;

S3: judging whether verification passes at least from dimensionality of a comparison result of the trajectory information and the preset trajectory.

As a further improvement of the embodiment of the present disclosure, step S3 specifically comprises:

judging whether a deviation of the trajectory information from the preset trajectory is within a preset permissible range, and judging that the verification passes if the deviation of the trajectory information from the preset trajectory is within the preset permissible range.

As a further improvement of the embodiment of the present disclosure, step S3 specifically comprises:

judging whether time of the terminal inputting the trajectory information is within a prescribed time period, and whether the deviation of the trajectory information from the preset trajectory is within a preset permissible range; and

judging successful pass of the verification if the time of the terminal inputting the trajectory information is within a prescribed time period, and the deviation of the trajectory information from the preset trajectory is within a preset permissible range.

As a further improvement of the embodiment of the present disclosure, the preset trajectory is generated randomly, and is a bent line consisting of at least two line segments.

As a further improvement of the embodiment of the present disclosure, the step of “comparing the trajectory information with a preset trajectory” specifically comprises:

receiving multi-sampling point information once at an interval of a predetermined cycle during input of the trajectory information by the terminal, and comparing the trajectory information with the preset trajectory according to coordinates of multiple sampling points on a verification interface.

As a further improvement of the embodiment of the present disclosure, the step “judging whether the deviation of the trajectory information from the preset trajectory is within a preset permissible range” specifically comprises:

calculating a first distance between a first sampling point in the trajectory information and a corresponding initial end point in the preset trajectory, and judging whether the first distance exceeds a preset first threshold;

calculating a second distance between last sampling point in the trajectory information and a corresponding last end point in the preset trajectory, and judging whether the second distance exceeds a preset second threshold;

calculating a third distance between any sampling point between the initial end point and the last end point in the trajectory information and the preset trajectory, and judging whether the third distance exceeds a preset third threshold;

if the respective distances calculated above all fail to exceed respective preset thresholds, the deviation of the trajectory information from the preset trajectory is within a preset permissible range, otherwise the deviation of the trajectory information from the preset trajectory is not in a preset permissible range.

As a further improvement of the embodiment of the present disclosure, the step “judging whether time of the terminal inputting the trajectory information is within a prescribed time period” comprises:

receiving multi-sampling point information once at an interval of a predetermined cycle during input of the trajectory information by the terminal, if the number of the sampling points exceeds a preset number of sampling points, the time of the terminal inputting the trajectory information is not within the prescribed time period;

if the number of the sampling points does not exceed the preset number of sampling points, the time of the terminal inputting the trajectory information is within the prescribed time period.

As a further improvement of the embodiment of the present disclosure, the method further comprises:

generating at least three random points on the verification interface and connecting all random points in turn as a preset trajectory to form a verification code;

sending the verification code to the terminal for display.

As a further improvement of the embodiment of the present disclosure, before “forming the verification code”, the method further comprises:

putting a starting point icon to a certain end point of the preset trajectory as an initial end point of the preset trajectory.

As a further improvement of the embodiment of the present disclosure, before “forming the verification code”, the method further comprises:

randomly generating at least one interference line on the verification interface, the interference line having a trajectory different from the preset trajectory.

To implement one of the above objectives of the present disclosure, an embodiment of the present disclosure provides a verification apparatus for distinguishing a man from a machine, comprising:

a communication module configured to receive trajectory information input by a terminal;

a verification module configured to compare the trajectory information with a preset trajectory, and judge whether verification passes at least from dimensionality of a comparison result of the trajectory information and the preset trajectory.

As a further improvement of the embodiment of the present disclosure, the verification module is configured to:

judge whether a deviation of the trajectory information from the preset trajectory is within a preset permissible range, and judge that the verification passes if the deviation of the trajectory information from the preset trajectory is within the preset permissible range.

As a further improvement of the embodiment of the present disclosure, the verification module is configured to:

judge whether time of the terminal inputting the trajectory information is within a prescribed time period, and judge whether the deviation of the trajectory information from the preset trajectory is within a preset permissible range; and

judge successful pass of the verification if the time of the terminal inputting the trajectory information is within a prescribed time period, and the deviation of the trajectory information from the preset trajectory is within a preset permissible range.

As a further improvement of the embodiment of the present disclosure, the preset trajectory is generated randomly, and is a bent line consisting of at least two line segments.

As a further improvement of the embodiment of the present disclosure, the communication module is further configured to: receive multi-sampling point information once at an interval of a predetermined cycle during input of the trajectory information by the terminal;

the verification module is configured to compare the trajectory information with the preset trajectory according to coordinates of multiple sampling points on a verification interface.

As a further improvement of the embodiment of the present disclosure, the verification module is configured to:

calculate a first distance between a first sampling point in the trajectory information and a corresponding initial end point in the preset trajectory, and judge whether the first distance exceeds a preset first threshold;

calculate a second distance between last sampling point in the trajectory information and a corresponding last end point in the preset trajectory, and judge whether the second distance exceeds a preset second threshold;

calculate a third distance between any sampling point between the initial end point and the last end point in the trajectory information and the preset trajectory, and judge whether the third distance exceeds a preset third threshold;

if the respective distances calculated above all fail to exceed respective preset thresholds, the deviation of the trajectory information from the preset trajectory is within a preset permissible range, otherwise the deviation of the trajectory information from the preset trajectory is not in a preset permissible range.

As a further improvement of the embodiment of the present disclosure, the communication module is further configured to: receive multi-sampling point information once at an interval of a predetermined cycle during input of the trajectory information by the terminal,

the verification module is configured to: if the number of the sampling points exceeds a preset number of sampling points, the time of the terminal inputting the trajectory information is not within the prescribed time period; if the number of the sampling points does not exceed the preset number of sampling points, the time of the terminal inputting the trajectory information is within the prescribed time period.

As a further improvement of the embodiment of the present disclosure, the apparatus further comprises a verification code building module configured to: generate at least three random points on the verification interface and connect all random points in turn as a preset trajectory to form a verification code;

the communication module is further configured to send the verification code to the terminal for display.

As a further improvement of the embodiment of the present disclosure, the verification code building module is configured to:

put a starting point icon to a certain end point of the preset trajectory as an initial end point of the preset trajectory.

As a further improvement of the embodiment of the present disclosure, the verification code building module is configured to:

randomly generate at least one interference line on the verification interface, the interference line having a trajectory different from the preset trajectory.

As compared with the prior art, the verification method and apparatus for distinguishing a man from a machine in the present disclosure may recognize user identity through simpler operation, and particularly applied to the mobile device, may bring about better user experience, and meanwhile exhibit very high security and difficulty in cracking the machine.

### BRIEF DESCRIPTION OF DRAWINGS

FIG. 1 is a diagram of system architecture of a verification method and apparatus for distinguishing a man from a machine in an embodiment of the present disclosure;

FIG. 2 is a flow chart of a verification method for distinguishing a man from a machine in the present disclosure;

FIG. 3 is a flow chart of a verification method for distinguishing a man from a machine in a first embodiment of the present disclosure;

FIG. 4a is a schematic diagram of a verification interface in an example of the present disclosure;

FIG. 4b is a schematic diagram of a verification interface in another example of the present disclosure;

FIG. 5 is a flow chart of a verification method for distinguishing a man from a machine in a second embodiment of the present disclosure;

FIG. 6 is a block diagram of a verification apparatus for distinguishing a man from a machine in the present disclosure.

### DETAILED DESCRIPTION OF PREFERRED EMBODIMENTS

The present disclosure will be described in detail in conjunction with figures and specific embodiments to make objectives, technical solutions and advantages of the present disclosure more apparent.

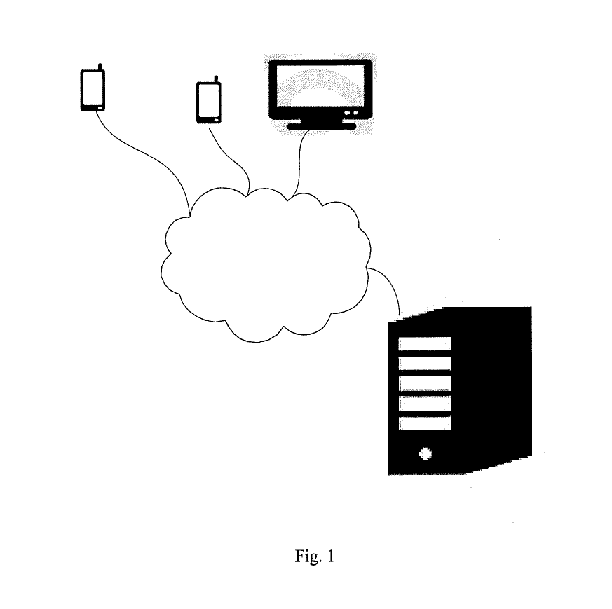

As shown in FIG. 1, a system of the verification method and apparatus for distinguishing a man from a machine in the present disclosure comprises a terminal (e.g., a mobile device, PC or the like) and a server. Both the terminal and the server may interact information via a network. A main purpose of the verification is to distinguish whether a man or a machine inputs a verification code on the terminal. Generally, like other verifications for distinguishing a man from a machine, this verification aims to provide a threshold and avoid a machine from operating the terminal. An original intention of the design of this type of verification is: in the case of successful pass of the verification, a man is operating the terminal.

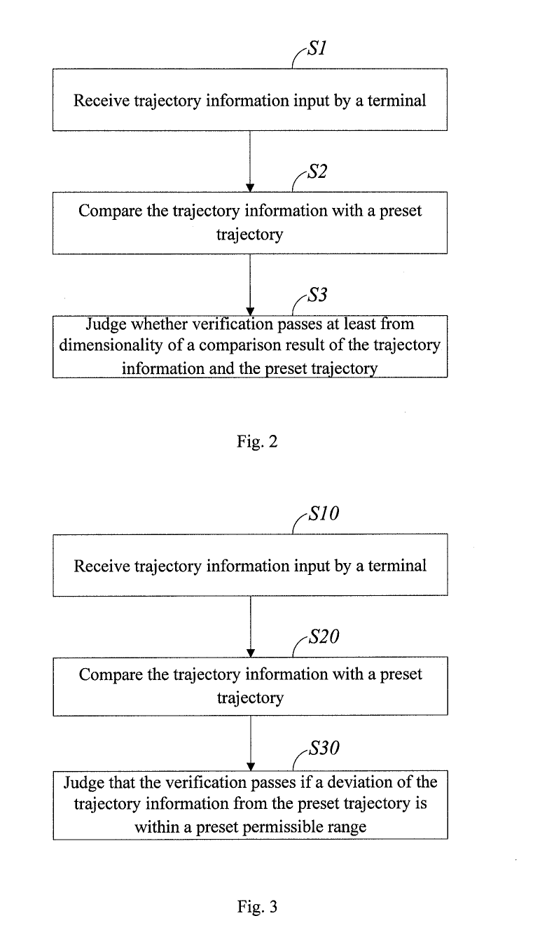

As shown in FIG. 2, the verification method for distinguishing a man from a machine according to the present disclosure comprises:

S1: receiving trajectory information input by a terminal;

S2: comparing the trajectory information with a preset trajectory;

S3: judging whether verification passes at least from dimensionality of a comparison result of the trajectory information and the preset trajectory.

Specifically, this will be described in detail through the following two embodiments:

### The First Embodiment

As shown in FIG. 3, the verification method for distinguishing a man from a machine comprises:

S10: receiving trajectory information input by a terminal;

S20: comparing the trajectory information with a preset trajectory;

S30: judging that the verification passes if a deviation of the trajectory information from the preset trajectory is within a preset permissible range.

In the present embodiment, the trajectory information is input by a man or machine to the terminal. After the terminal receives the input trajectory information, it may transmit the trajectory information to the server through a network. The server may judge whether the verification passes according to the trajectory information.

The verification method and apparatus for distinguishing a man from a machine in the present disclosure may be used for the mobile device and the PC. The trajectory information may be input at the terminal via a mouse or an operation such as touch. When the terminal has a touch screen, the trajectory information is touch slide information displayed by the terminal on the verification interface. The mobile terminal is mainly taken as an example for detailed illustration.

Furthermore, to enhance accuracy of the verification and avoid cracking of the machine, in the present embodiment, the preset trajectory is a bent line consisting of at least two line segments, that is, the preset trajectory comprises a starting point, a finishing point, and at least one intermediate point between the starting point and the finishing point. The preset trajectory is a trajectory connecting these points together. Generally, the preset trajectory involved by each verification is generated randomly to further avoid the cracking of the machine.

Furthermore, in the present embodiment, the step of “comparing the trajectory information with a preset trajectory” specifically comprises:

receiving multi-sampling point information once at an interval of a predetermined cycle (e.g., 0.1 seconds) during input of the trajectory information by the terminal, and comparing the trajectory information with the preset trajectory according to coordinates of multiple sampling points on a verification interface.

Specifically, it is feasible to performing verification through the sampling points in the present embodiment. Performing verification through the sampling points specifically comprises:

calculating a first distance between a first sampling point in the trajectory information and a corresponding initial end point in the preset trajectory, and judging whether the first distance exceeds a preset first threshold;

calculating a second distance between last sampling point in the trajectory information and a corresponding last end point in the preset trajectory, and judging whether the second distance exceeds a preset second threshold;

calculating a third distance between any sampling point between the initial end point and the last end point in the trajectory information and the preset trajectory, and judging whether the third distance exceeds a preset third threshold;

if the respective distances calculated above all fail to exceed respective preset thresholds, the deviation of the trajectory information from the preset trajectory is within a preset permissible range, otherwise the deviation of the trajectory information from the preset trajectory is not within a preset permissible range.

Wherein, the first threshold, the second threshold and the third threshold may be set as different distances or the same distance. The exceeding may be set as meaning greater than or equal to, or may be set as meaning greater than; not exceeding may be set as meaning smaller than or equal to, or may be set as meaning smaller than. One of two end points of the above bent line is the initial end point, namely the starting point; the other of the two end points of the above bent line is the last end point, namely, the finishing point. The first sampling point is the sampling point where sampling of the first time is performed during input of the preset trajectory, and the last sampling point is a sampling point where sampling of final time is performed during input of the preset trajectory.

Furthermore, in the present embodiment, the method further comprises:

generating at least three random points on the verification interface and connecting all random points in turn as a preset trajectory to form a verification code;

sending the verification code to the terminal for display.

Specifically, in the present embodiment, it is feasible to form the verification code through the server, the verification code comprising a verification interface, and verify content in the verification interface. As stated above, the preset trajectory is displayed on the verification interface. Certainly, after the random points are generated, the server may store the random points, or random points and preset trajectory (a sole identifier may be marked for a set of random points to facilitate subsequent confirmation of a correspondence relationship) to facilitate subsequent comparison with the input trajectory information.

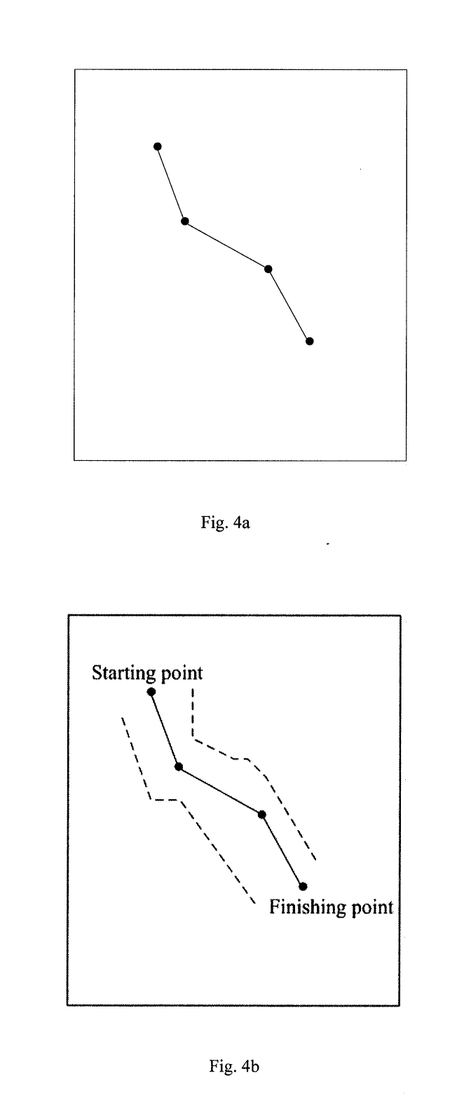

In an example shown in FIG. 4a, four random points are randomly generated on the verification interface, and the four random points are connected in turn to form the preset trajectory. One of two end points of the present trajectory may be the starting point, and the other may be the finishing point. Any one of the starting point and finishing point may be selected when the trajectory information is input on the terminal.

Furthermore, in the present embodiment, before “forming the verification code”, the method further comprises:

putting a starting point icon to a certain end point of the preset trajectory as an initial end point of the preset trajectory; and/or putting a finishing point icon to a certain end point or another end point of the preset trajectory, as last end point of the preset trajectory. In another example shown in FIG. 4b, the present example differs from the above example in specifying the starting point and the finishing point. As such, it is feasible to prompt from which end point the trajectory information begins to be input, and consider the initial end point and last end point upon subsequent verification.

Furthermore, in the present embodiment, before “forming the verification code”, the method further comprises:

randomly generating at least one interference line on the verification interface, the interference line having a trajectory different from the preset trajectory.

As shown in FIG. 4b, to prevent the machine from identifying the preset trajectory, at least one interference line is further generated on the verification interface to further avoid the cracking of the machine.

### The Second Embodiment

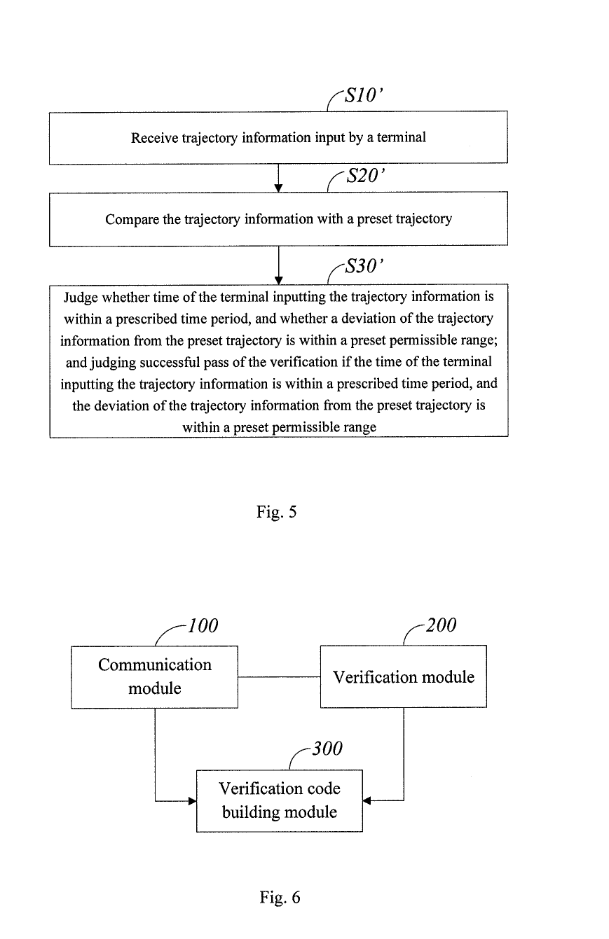

As shown in FIG. 5, the verification method for distinguishing a man from a machine comprises:

S10′: receiving trajectory information input by a terminal;

S20′: comparing the trajectory information with a preset trajectory;

S30′: judging whether time of the terminal inputting the trajectory information is within a prescribed time period, and whether a deviation of the trajectory information from the preset trajectory is within a preset permissible range; and judging successful pass of the verification if the time of the terminal inputting the trajectory information is within a prescribed time period, and the deviation of the trajectory information from the preset trajectory is within a preset permissible range.

The present embodiment differs from the above embodiment in that the present embodiment considers whether the verification passes from a matching degree of the trajectory information as well as from time dimensionality.

In the present embodiment, the trajectory information is input by a man or machine to the terminal. After the terminal receives the input trajectory information, it may transmit the trajectory information to the server through a network. The server may judge whether the verification passes according to the trajectory information.

The verification method and apparatus for distinguishing a man from a machine in the present disclosure may be used for the mobile device and the PC. The trajectory information may be input at the terminal via a mouse or an operation such as touch. When the terminal has a touch screen, the trajectory information is touch slide information displayed by the terminal on the verification interface. The mobile terminal is mainly taken as an example for detailed illustration.

Furthermore, to enhance accuracy of the verification and avoid cracking of the machine, in the present embodiment, the preset trajectory is a bent line consisting of at least two line segments, that is, the preset trajectory comprises a starting point, a finishing point, and at least one intermediate point between the starting point and the finishing point. The preset trajectory is a trajectory connecting these points together. Generally, the preset trajectory involved by each verification is generated randomly to further avoid the cracking of the machine.

Specifically, the input time may be obtained by recording time of trajectory information operation, or may be obtained by calculating. In the present embodiment, it is feasible to calculate whether the input time meets requirements through sampling point information. Specifically, the step “judging whether time of the terminal inputting the trajectory information is within a prescribed time period” comprises:

receiving multi-sampling point information once at an interval of a predetermined cycle (e.g., 0.1 seconds) during input of the trajectory information by the terminal;

if the number of the sampling points exceeds a preset number of sampling points, the time of the terminal inputting the trajectory information is not within a prescribed time period;

if the number of the sampling points does not exceed a preset number of sampling points, the time of the terminal inputting the trajectory information is within a prescribed time period;

Furthermore, in the present embodiment, judging whether a deviation of the trajectory information from the preset trajectory is within a preset permissible range specifically comprises:

calculating a first distance between a first sampling point in the trajectory information and a corresponding initial end point in the preset trajectory, and judging whether the first distance exceeds a preset first threshold;

calculating a second distance between last sampling point in the trajectory information and a corresponding last end point in the preset trajectory, and judging whether the second distance exceeds a preset second threshold;

calculating a third distance between any sampling point between the initial end point and the last end point in the trajectory information and the preset trajectory, and judging whether the third distance exceeds a preset third threshold;

if the respective distances calculated above all fail to exceed respective preset thresholds, the deviation of the trajectory information from the preset trajectory is within a preset permissible range, otherwise the deviation of the trajectory information from the preset trajectory is not within a preset permissible range.

Wherein, the first threshold, the second threshold and the third threshold may be set as different distances or the same distance. The exceeding may be set as meaning greater than or equal to, or may be set as meaning greater than; not exceeding may be set as meaning smaller than or equal to, or may be set as meaning smaller than. One of two end points of the above bent line is the initial end point, namely the starting point; the other of the two end points of the above bent line is the last end point, namely, the finishing point. The first sampling point is the sampling point where sampling of the first time is performed during input of the preset trajectory, and the last sampling point is a sampling point where sampling of final time is performed during input of the preset trajectory.

Furthermore, in the present embodiment, the method further comprises:

generating at least three random points on the verification interface and connecting all random points in turn as a preset trajectory to form a verification code;

sending the verification code to the terminal for display.

Specifically, in the present embodiment, it is feasible to form the verification code through the server, the verification code comprising a verification interface, and verify content in the verification interface. As stated above, the preset trajectory is displayed on the verification interface. Certainly, after the random points are generated, the server may store the random points, or random points and preset trajectory (a sole identifier may be marked for a set of random points to facilitate subsequent confirmation of a correspondence relationship) to facilitate subsequent comparison with the input trajectory information.

In an example shown in FIG. 4a, four random points are randomly generated on the verification interface, and the four random points are connected in turn to form the preset trajectory. One of two end points of the present trajectory may be the starting point, and the other may be the finishing point. Any one of the starting point and finishing point may be selected when the trajectory information is input on the terminal.

Furthermore, in the present embodiment, before “forming the verification code”, the method further comprises:

putting a starting point icon to a certain end point of the preset trajectory as an initial end point of the preset trajectory; and/or putting a finishing point icon to a certain end point or another end point of the preset trajectory, as last end point of the preset trajectory. In another example shown in FIG. 4b, the present example differs from the above example in specifying the starting point and the finishing point. As such, it is feasible to prompt from which end point the trajectory information begins to be input, and consider the initial end point and last end point upon subsequent verification.

Furthermore, in the present embodiment, before “forming the verification code”, the method further comprises:

randomly generating at least one interference line on the verification interface, the interference line having a trajectory different from the preset trajectory.

As shown in FIG. 4b, to prevent the machine from identifying the preset trajectory, at least one interference line is further generated on the verification interface to further avoid the cracking of the machine.

As shown in FIG. 6, the verification apparatus for distinguishing a man from a machine according to an embodiment of the present disclosure comprises:

a communication module 100 configured to receive trajectory information input by a terminal;

a verification module 200 configured to compare the trajectory information with a preset trajectory; and judge whether verification passes at least from dimensionality of a comparison result of the trajectory information and the preset trajectory.

Specifically, this will be described in detail through the following two embodiments:

In the first embodiment, the verification apparatus for distinguishing a man from a machine comprises:

a communication module 100 configured to receive trajectory information input by a terminal;

a verification module 200 configured to compare the trajectory information with a preset trajectory, and judge that the verification passes if a deviation of the trajectory information from the preset trajectory is within a preset permissible range.

In the present embodiment, the trajectory information is input by a man or machine to the terminal. After the terminal receives the input trajectory information, it may transmit the trajectory information to the server through a network. The server may judge whether the verification passes according to the trajectory information.

The verification method and apparatus for distinguishing a man from a machine in the present disclosure may be used for the mobile device and the PC. The trajectory information may be input at the terminal via a mouse or an operation such as touch. When the terminal has a touch screen, the trajectory information is touch slide information displayed by the terminal on the verification interface. The mobile terminal is mainly taken as an example for detailed illustration.

Furthermore, to enhance accuracy of the verification and avoid cracking of the machine, in the present embodiment, the preset trajectory is a bent line consisting of at least two line segments, that is, the preset trajectory comprises a starting point, a finishing point, and at least one intermediate point between the starting point and the finishing point. The preset trajectory is a trajectory connecting these points together. Generally, the preset trajectory involved by each verification is generated randomly to further avoid the cracking of the machine.

Furthermore, in the present embodiment, the communication module 100 is further configured to receive multi-sampling point information once at an interval of a predetermined cycle (e.g., 0.1 seconds) during input of the trajectory information by the terminal;

the verification module 200 is configured to compare the trajectory information with the preset trajectory according to coordinates of multiple sampling points on a verification interface.

Specifically, it is feasible to perform verification through the sampling points in the present embodiment. The verification module 200 is configured to:

calculate a first distance between a first sampling point in the trajectory information and a corresponding initial end point in the preset trajectory, and judge whether the first distance exceeds a preset first threshold;

calculate a second distance between last sampling point in the trajectory information and a corresponding last end point in the preset trajectory, and judge whether the second distance exceeds a preset second threshold;

calculate a third distance between any sampling point between the initial end point and the last end point in the trajectory information and the preset trajectory, and judge whether the third distance exceeds a preset third threshold;

if the respective distances calculated above all fail to exceed respective preset thresholds, the deviation of the trajectory information from the preset trajectory is within a preset permissible range, otherwise the deviation of the trajectory information from the preset trajectory is not within a preset permissible range.

Wherein, the first threshold, the second threshold and the third threshold may be set as different distances or the same distance. The exceeding may be set as meaning greater than or equal to, or may be set as meaning greater than; not exceeding may be set as meaning smaller than or equal to, or may be set as meaning smaller than. One of two end points of the above bent line is the initial end point, namely the starting point; the other of the two end points of the above bent line is the last end point, namely, the finishing point. The first sampling point is the sampling point where sampling of the first time is performed during input of the preset trajectory, and the last sampling point is a sampling point where sampling of final time is performed during input of the preset trajectory.

Furthermore, in the present embodiment, the apparatus further comprises a verification code building module 300 configured to:

generate at least three random points on the verification interface and connect all random points in turn as a preset trajectory to form a verification code;

the communication module 100 is further configured to send the verification code to the terminal for display.

Specifically, in the present embodiment, it is feasible to form the verification code through the server, the verification code comprising a verification interface, and verify content in the verification interface. As stated above, the preset trajectory is displayed on the verification interface. Certainly, after the random points are generated, the server may store the random points, or random points and preset trajectory (a sole identifier may be marked for a set of random points to facilitate subsequent confirmation of a correspondence relationship) to facilitate subsequent comparison with the input trajectory information.

In an example shown in FIG. 4a, four random points are randomly generated on the verification interface, and the four random points are connected in turn to form the preset trajectory. One of two end points of the present trajectory may be the starting point, and the other may be the finishing point. Any one of the starting point and finishing point may be selected when the trajectory information is input on the terminal.

Furthermore, in the present embodiment, the verification code building module 300 is further configured to:

put a starting point icon to a certain end point of the preset trajectory as an initial end point of the preset trajectory; and/or put a finishing point icon to a certain end point or another end point of the preset trajectory, as last end point of the preset trajectory. In another example shown in FIG. 4b, the present example differs from the above example in specifying the starting point and the finishing point. As such, it is feasible to prompt from which end point the trajectory information begins to be input, and consider the initial end point and last end point upon subsequent verification.

Furthermore, in the present embodiment, the verification code building module 300 is further configured to:

randomly generate at least one interference line on the verification interface, the interference line having a trajectory different from the preset trajectory.

As shown in FIG. 4b, to prevent the machine from identifying the preset trajectory, at least one interference line is further generated on the verification interface to further avoid the cracking of the machine.

In the second embodiment, the verification apparatus for distinguishing a man from a machine comprises:

a communication module 100 configured to receive trajectory information input by a terminal;

a verification module 200 configured to judge whether time of the terminal inputting the trajectory information is within a prescribed time period, and whether a deviation of the trajectory information from the preset trajectory is within a preset permissible range;

and judge successful pass of the verification if the time of the terminal inputting the trajectory information is within a prescribed time period, and the deviation of the trajectory information from the preset trajectory is within a preset permissible range.

The present embodiment differs from the above embodiment in that the present embodiment considers whether the verification passes from a matching degree of the trajectory information as well as from time dimensionality.

In the present embodiment, the trajectory information is input by a man or machine to the terminal. After the terminal receives the input trajectory information, it may transmit the trajectory information to the server through a network. The server may judge whether the verification passes according to the trajectory information. The verification method and apparatus for distinguishing a man from a machine in the present disclosure may be used for the mobile device and the PC. The trajectory information may be input at the terminal via a mouse or an operation such as touch. When the terminal has a touch screen, the trajectory information is touch slide information displayed by the terminal on the verification interface. The mobile terminal is mainly taken as an example for detailed illustration.

Furthermore, to enhance accuracy of the verification and avoid cracking of the machine, in the present embodiment, the preset trajectory is a bent line consisting of at least two line segments, that is, the preset trajectory comprises a starting point, a finishing point, and at least one intermediate point between the starting point and the finishing point. The preset trajectory is a trajectory connecting these points together. Generally, the preset trajectory involved by each verification is generated randomly to further avoid the cracking of the machine.

Specifically, the input time may be obtained by recording time of trajectory information operation, or may be obtained by calculating. In the present embodiment, it is feasible to calculate whether the input time meets requirements through sampling point information. Specifically,

the communication module 100 is further configured to receive multi-sampling point information once at an interval of a predetermined cycle (e.g., 0.1 seconds) during input of the trajectory information by the terminal;

the verification module 200 is configured in a way that if the number of the sampling points exceeds a preset number of sampling points, the time of the terminal inputting the trajectory information is not within a prescribed time period;

if the number of the sampling points does not exceed a preset number of sampling points, the time of the terminal inputting the trajectory information is within a prescribed time period.

Furthermore, in the present embodiment, judgement is made as to whether a deviation of the trajectory information from the preset trajectory is within a preset permissible range. The verification module 200 is configured to:

calculate a first distance between a first sampling point in the trajectory information and a corresponding initial end point in the preset trajectory, and judge whether the first distance exceeds a preset first threshold;

calculate a second distance between last sampling point in the trajectory information and a corresponding last end point in the preset trajectory, and judge whether the second distance exceeds a preset second threshold;

calculate a third distance between any sampling point between the initial end point and the last end point in the trajectory information and the preset trajectory, and judge whether the third distance exceeds a preset third threshold;

if the respective distances calculated above all fail to exceed respective preset thresholds, the deviation of the trajectory information from the preset trajectory is within a preset permissible range, otherwise the deviation of the trajectory information from the preset trajectory is not within a preset permissible range.

Wherein, the first threshold, the second threshold and the third threshold may be set as different distances or the same distance. The exceeding may be set as meaning greater than or equal to, or may be set as meaning greater than; not exceeding may be set as meaning smaller than or equal to, or may be set as meaning smaller than. One of two end points of the above bent line is the initial end point, namely the starting point; the other of the two end points of the above bent line is the last end point, namely, the finishing point. The first sampling point is the sampling point where sampling of the first time is performed during input of the preset trajectory, and the last sampling point is a sampling point where sampling of final time is performed during input of the preset trajectory.

Furthermore, in the present embodiment, the apparatus further comprises a verification code building module 300 configured to:

generate at least three random points on the verification interface and connect all random points in turn as a preset trajectory to form a verification code;

the communication module 100 is further configured to send the verification code to the terminal for display.

Specifically, in the present embodiment, it is feasible to form the verification code through the server, the verification code comprising a verification interface, and verify content in the verification interface. As stated above, the preset trajectory is displayed on the verification interface. Certainly, after the random points are generated, the server may store the random points, or random points and preset trajectory (a sole identifier may be marked for a set of random points to facilitate subsequent confirmation of a correspondence relationship) to facilitate subsequent comparison with the input trajectory information.

In an example shown in FIG. 4a, four random points are randomly generated on the verification interface, and the four random points are connected in turn to form the preset trajectory. One of two end points of the present trajectory may be the starting point, and the other may be the finishing point. Any one of the starting point and finishing point may be selected when the trajectory information is input on the terminal.

Furthermore, in the present embodiment, the verification code building module 300 is further configured to:

put a starting point icon to a certain end point of the preset trajectory as an initial end point of the preset trajectory; and/or put a finishing point icon to a certain end point or another end point of the preset trajectory, as last end point of the preset trajectory. In another example shown in FIG. 4b, the present example differs from the above example in specifying the starting point and the finishing point. As such, it is feasible to prompt from which end point the trajectory information begins to be input, and consider the initial end point and last end point upon subsequent verification.

Furthermore, in the present embodiment, the verification code building module 300 is further configured to:

randomly generating at least one interference line on the verification interface, the interference line having a trajectory different from the preset trajectory.

As shown in FIG. 4b, to prevent the machine from identifying the preset trajectory, at least one interference line is further generated on the verification interface to further avoid the cracking of the machine.

To conclude, the verification method and apparatus for distinguishing a man from a machine in the present disclosure may recognize user identity through simpler operation, and particularly applied to the mobile device, may bring about better user experience, and meanwhile exhibit very high security and difficulty in cracking the machine.

Those skilled in the art can clearly understand that for purpose of convenience and brevity of depictions, reference may be made to corresponding procedures in the aforesaid method embodiments for specific operation procedures of the system, apparatus and modules described above, which will not be detailed any more.

In the embodiments provided by the present disclosure, it should be understood that the revealed system, apparatus and method can be implemented through other ways. For example, the above-described embodiments for the apparatus are only exemplary, e.g., the division of the modules is merely logical one, and, in reality, they can be divided in other ways upon embodiment. For example, a plurality of modules or components may be combined or integrated into another system, or some features may be neglected or not executed. In addition, mutual coupling or direct coupling or communicative connection as displayed or discussed may be indirect coupling or communicative connection performed via some interfaces, means or modules and may be electrical, mechanical or in other forms.

The modules described as separate parts may be or may not be physically separated, the parts shown as modules may be or may not be physical modules, i.e., they can be located in one place, or distributed in a plurality of network modules. One can select some or all the modules to achieve the purpose of the embodiment according to the actual needs.

Further, in the embodiments of the present disclosure, functional modules can be integrated in one processing module, or they can be separate physical presences; or two or more modules can be integrated in one module. The integrated module described above can be implemented in the form of hardware, or they can be implemented with hardware plus software functional modules.

The aforementioned integrated module in the form of software function modules may be stored in a computer readable storage medium. The aforementioned software function modules are stored in a storage medium, including several instructions to instruct a computer device (a personal computer, server, or network equipment, etc.)

or processor to perform some steps of the method described in the various embodiments of the present disclosure. The aforementioned storage medium includes various media that may store program codes, such as U disk, removable hard disk, read-only memory (ROM), a random access memory (RAM), magnetic disk, or an optical disk.

What are stated above are only preferred embodiments of the present disclosure, not intended to limit the disclosure. Any modifications, equivalent replacements, improvements and the like made within the spirit and principles of the present disclosure, should all be included in the present disclosure within the scope of protection.

What is claimed is:

1. A verification method for distinguishing a man from a machine, comprising:
S1: receiving trajectory information input by a terminal;
S2: comparing the trajectory information with a preset trajectory;
S3: judging whether verification passes at least from dimensionality of a comparison result of the trajectory information and the preset trajectory.

2. The verification method for distinguishing a man from a machine according to claim 1, wherein the step S3 specifically comprises:
judging whether a deviation of the trajectory information from the preset trajectory is within a preset permissible range, and judging that the verification passes if the deviation of the trajectory information from the preset trajectory is within the preset permissible range; or judging whether time of the terminal inputting the trajectory information is within a prescribed time period, and judging whether the deviation of the trajectory information from the preset trajectory is within a preset permissible range; and
judging successful pass of the verification if the time of the terminal inputting the trajectory information is within a prescribed time period, and the deviation of the trajectory information from the preset trajectory is within a preset permissible range.

3. (canceled)

4. The verification method for distinguishing a man from a machine according to claim 1, wherein the preset trajectory is generated randomly, and is a bent line consisting of at least two line segments.

5. The verification method for distinguishing a man from a machine according to claim 1, wherein the step of “comparing the trajectory information with a preset trajectory” specifically comprises:
receiving multi-sampling point information once at an interval of a predetermined cycle during input of the trajectory information by the terminal, and comparing the trajectory information with the preset trajectory according to coordinates of multiple sampling points on a verification interface.

6. The verification method for distinguishing a man from a machine according to claim 2, wherein the step “judging whether the deviation of the trajectory information from the preset trajectory is within a preset permissible range” specifically comprises:
calculating a first distance between a first sampling point in the trajectory information and a corresponding initial end point in the preset trajectory, and judging whether the first distance exceeds a preset first threshold;
calculating a second distance between a last sampling point in the trajectory information and a corresponding last end point in the preset trajectory, and judging whether the second distance exceeds a preset second threshold;
calculating a third distance between any sampling point between the initial end point and the last end point in the trajectory information and the preset trajectory, and judging whether the third distance exceeds a preset third threshold;
if the respective distances calculated above all fail to exceed respective preset thresholds, the deviation of the trajectory information from the preset trajectory is within a preset permissible range, otherwise the deviation of the trajectory information from the preset trajectory is not in a preset permissible range.

7. The verification method for distinguishing a man from a machine according to claim 2, wherein the step “judging whether time of the terminal inputting the trajectory information is within a prescribed time period” specifically comprises:
receiving multi-sampling point information once at an interval of a predetermined cycle during input of the trajectory information by the terminal,
if the number of the sampling points exceeds a preset number of sampling points, the time of the terminal inputting the trajectory information is not within the prescribed time period;
if the number of the sampling points does not exceed the preset number of sampling points, the time of the terminal inputting the trajectory information is within the prescribed time period.

8. The verification method for distinguishing a man from a machine according to claim 4, wherein the method further comprises:
generating at least three random points on the verification interface and connecting all random points in turn as a preset trajectory to form a verification code;
sending the verification code to the terminal for display; wherein, before “forming a verification code”, the method further comprises:
putting a starting point icon to a certain end point of the preset trajectory as an initial end point of the preset trajectory; or
randomly generating at least one interference line on the verification interface, the interference line having a trajectory different from the preset trajectory.

9. (canceled)

10. (canceled)

11. An apparatus, comprising
one or more processors;
a memory;
one or more programs stored in the memory and configured to execute the following operations when executed by the one or more processors:
receiving trajectory information input by a terminal;
comparing the trajectory information with a preset trajectory;
judging whether verification passes at least from dimensionality of a comparison result of the trajectory information and the preset trajectory.

12-20. (canceled)

21. The Apparatus according to claim 11, wherein the operation of judging whether verification passes at least from dimensionality of a comparison result of the trajectory information and the preset trajectory comprises:
judging whether a deviation of the trajectory information from the preset trajectory is within a preset permissible range, and judging that the verification passes if the deviation of the trajectory information from the preset trajectory is within the preset permissible range; or
judging whether time of the terminal inputting the trajectory information is within a prescribed time period, and judging whether the deviation of the trajectory information from the preset trajectory is within a preset permissible range, and judging successful pass of the verification if the time of the terminal inputting the trajectory information is within a prescribed time period, and the deviation of the trajectory information from the preset trajectory is within a preset permissible range.

22. The Apparatus according to claim 11, wherein the preset trajectory is generated randomly, and is a bent line consisting of at least two line segments.

23. The Apparatus according to claim 11, wherein the operation of comparing the trajectory information with a preset trajectory specifically comprises:
receiving multi-sampling point information once at an interval of a predetermined cycle during input of the trajectory information by the terminal, and comparing the trajectory information with the preset trajectory according to coordinates of multiple sampling points on a verification interface.

24. The Apparatus according to claim 23, wherein the operation judging whether the deviation of the trajectory information from the preset trajectory is within a preset permissible range specifically comprises:
calculating a first distance between a first sampling point in the trajectory information and a corresponding initial end point in the preset trajectory, and judging whether the first distance exceeds a preset first threshold;
calculating a second distance between a last sampling point in the trajectory information and a corresponding last end point in the preset trajectory, and judging whether the second distance exceeds a preset second threshold;
calculating a third distance between any sampling point between the initial end point and the last end point in the trajectory information and the preset trajectory, and judging whether the third distance exceeds a preset third threshold;
if the respective distances calculated above all fail to exceed respective preset thresholds, the deviation of the trajectory information from the preset trajectory is within a preset permissible range, otherwise the deviation of the trajectory information from the preset trajectory is not in a preset permissible range.

25. The Apparatus according to claim 21, wherein the operation of judging whether time of the terminal inputting the trajectory information is within a prescribed time period specifically comprises:
receiving multi-sampling point information once at an interval of a predetermined cycle during input of the trajectory information by the terminal,
if the number of the sampling points exceeds a preset number of sampling points, the time of the terminal inputting the trajectory information is not within the prescribed time period;
if the number of the sampling points does not exceed the preset number of sampling points, the time of the terminal inputting the trajectory information is within the prescribed time period.

26. The Apparatus according to claim 22, wherein the operation further comprises:
generating at least three random points on the verification interface and connecting all random points in turn as a preset trajectory to form a verification code;
sending the verification code to the terminal for display;
wherein, before forming a verification code, the operation further comprises:
putting a starting point icon to a certain end point of the preset trajectory as an initial end point of the preset trajectory; or
randomly generating at least one interference line on the verification interface, the interference line having a trajectory different from the preset trajectory.

27. A non-volatile computer storage medium in which one or more programs are stored, an apparatus being enabled to execute the following operation when said one or more programs are executed by the apparatus:
receiving trajectory information input by a terminal;
comparing the trajectory information with a preset trajectory;
judging whether verification passes at least from dimensionality of a comparison result of the trajectory information and the preset trajectory.

28. The non-volatile computer storage medium according to claim 27, wherein the operation of judging whether verification passes at least from dimensionality of a comparison result of the trajectory information and the preset trajectory comprises:
judging whether a deviation of the trajectory information from the preset trajectory is within a preset permissible range, and judging that the verification passes if the deviation of the trajectory information from the preset trajectory is within the preset permissible range; or
judging whether time of the terminal inputting the trajectory information is within a prescribed time period, and judging whether the deviation of the trajectory information from the preset trajectory is within a preset permissible range, and judging successful pass of the verification if the time of the terminal inputting the trajectory information is within a prescribed time period, and the deviation of the trajectory information from the preset trajectory is within a preset permissible range.

29. The non-volatile computer storage medium according to claim 27, wherein the preset trajectory is generated randomly, and is a bent line consisting of at least two line segments.

30. The non-volatile computer storage medium according to claim 27, wherein the operation of comparing the trajectory information with a preset trajectory specifically comprises:
receiving multi-sampling point information once at an interval of a predetermined cycle during input of the trajectory information by the terminal, and comparing the trajectory information with the preset trajectory according to coordinates of multiple sampling points on a verification interface.

31. The non-volatile computer storage medium according to claim 30, wherein the operation judging whether the deviation of the trajectory information from the preset trajectory is within a preset permissible range specifically comprises:
calculating a first distance between a first sampling point in the trajectory information and a corresponding initial end point in the preset trajectory, and judging whether the first distance exceeds a preset first threshold;
calculating a second distance between a last sampling point in the trajectory information and a corresponding last end point in the preset trajectory, and judging whether the second distance exceeds a preset second threshold;
calculating a third distance between any sampling point between the initial end point and the last end point in the trajectory information and the preset trajectory, and judging whether the third distance exceeds a preset third threshold;
if the respective distances calculated above all fail to exceed respective preset thresholds, the deviation of the trajectory information from the preset trajectory is within a preset permissible range, otherwise the deviation of the trajectory information from the preset trajectory is not in a preset permissible range.

32. The non-volatile computer storage medium according to claim 28, wherein the operation of judging whether time of the terminal inputting the trajectory information is within a prescribed time period specifically comprises:
receiving multi-sampling point information once at an interval of a predetermined cycle during input of the trajectory information by the terminal,
if the number of the sampling points exceeds a preset number of sampling points, the time of the terminal inputting the trajectory information is not within the prescribed time period;
if the number of the sampling points does not exceed the preset number of sampling points, the time of the terminal inputting the trajectory information is within the prescribed time period.

33. The non-volatile computer storage medium according to claim 29, wherein the operation further comprises:
generating at least three random points on the verification interface and connecting all random points in turn as a preset trajectory to form a verification code;
sending the verification code to the terminal for display;
wherein, before forming a verification code, the operation further comprises:
putting a starting point icon to a certain end point of the preset trajectory as an initial end point of the preset trajectory; or
randomly generating at least one interference line on the verification interface, the interference line having a trajectory different from the preset trajectory.
